(19) United States
(12) Patent Application Publication
(10) Pub. No.: US 2013/0201148 A1
(43) Pub. Date: Aug. 8, 2013

(54) TWO-FINGER GESTURE ON A LINEAR SENSOR OR SINGLE LAYER SENSOR

(71) Applicant: Keith L. Paulsen, Centerville, UT (US)

(72) Inventor: Keith L. Paulsen, Centerville, UT (US)

(21) Appl. No.: 13/571,097

(22) Filed: Aug. 9, 2012

Related U.S. Application Data
(63) Continuation-in-part of application No. 12/719,717, filed on Mar. 8, 2010.
(60) Provisional application No. 61/521,475, filed on Aug. 9, 2011.

(51) Int. Cl. G06F 3/044

(52) U.S. Cl. CPC G06F 3/044
USPC 345/174

(57) ABSTRACT

A linear sensor (a single electrode) or a single layer sensor (a plurality of parallel and planar electrodes) that may be used in a single layer sensor, wherein a pinching gesture by two fingers can be detected on the linear or single layer sensors by measuring and then integrating current to determine if a finger is moving away from or towards an edge of the sensor, or it can be determined if the distance between the fingers is changing.

### CROSS REFERENCE TO RELATED APPLICATIONS

This document claims priority to, and incorporates by reference all of the subject matter included in the provisional patent application docket number 5020.CIRQ.PR, having Ser. No. 61/521,475 and filed on Aug. 9, 2011, and is a. Continuation-in-Part of co-pending application 4519.CIRQ.CIP, having Ser. No. 12/719,717 and filed on Mar. 8, 2010.

### BACKGROUND OF THE INVENTION

1. Field of the Invention

This invention relates generally to touchpads using surface capacitance technology. More specifically, the present invention is a new method for identifying gestures that are based on two fingers placed in proximity of a resistive trace or a plurality of resistive traces.

2. Description of Related Art

Capacitive touch screens are readily available for use in diverse applications. As touch sensitive screens become more popular and more useful, the technologies to implement them are also evolving.

Several different touch screen and touchpad technologies have emerged including projected capacitance methods and surface capacitance methods. Projected capacitance methods are currently required to implement gestures that utilize more than one finger or pointing object on the surface at the same time.

For example, FIG. 1 is a top view of an array of orthogonal electrodes 6, such as a plurality of X (2) and Y (4) electrodes, which are often used in touchpad and touch screen technologies such as those produced by Cirque Corporation®. However, projected capacitance methods generally cost more to implement than surface capacitance methods because of the more intricate processes required to etch electrode patterns into a conductive surface.

An example of surface capacitance technology is shown in FIG. 2. Such a surface cap panel 10 is a solid sheet of a conductive material 16 disposed on an insulating substrate 18 such as glass, with sensors 12 disposed at the corners. The traditional method of measuring the position of a pointing object 14 or the “touch position” on the surface capacitance touch panel 10 is to apply an AC signal on all four corners of the touch panel's conductive layer 16. The conductive layer 16 can be made, for example, of Indium Tin Oxide (ITO).

To create the touch panel 10, the surface of the glass substrate 18 is flooded or covered with a substantially even layer of a resistive ITO material which forms a sheet resistance. A dielectric is then applied to cover the ITO conductive material.

After applying the AC signal to the conductive ITO material 16, the next step is to triangulate the touch position using the current flowing through each corner. It is common to apply either a sine wave or a square wave.

If an object such as a finger 14 comes in contact with the surface of the touch panel 10, a capacitor is formed between the ITO surface 16 and the finger tip 14. The capacitance value is very small, typically in the order of 50 pF. The amount of charge or current that has to be measured going into each corner 12 of the panel is therefore very small. Because the current is so small, the system is very susceptible to stray capacitance. Thus, the accuracy of touch panels 10 is often an issue.

With these two different touch technologies in mind, it is observed that software applications in portable and stationary electronic appliances such as computers, smart phones, and any other device that can use a touch interface, are now beginning to use a second point of contact (such as a finger and thumb or two fingers) to support gestures such as “pinch and zoom”, pan, rotate, etc. Other applications use a third simultaneous contact for a “next and previous” gesture, and even a fourth simultaneous contact for switching between applications.

Multi-finger gestures can also be accomplished using an “area gesture”, such as in the method taught by Cirque Corporation®, wherein multiple contacts are not tracked but instead the area gesture is accomplished by seeing the multiple contacts as only a single large object, where the multiple contacts only define the outer boundaries of the large object. The multiple points of contact can therefore be considered to have a height and a width.

Operating system software and Human Interface Device (RIG) standards are being modified to include these new gestures and methods of reporting multi-finger contact with a touch sensitive surface.

Unfortunately, it has not been possible to utilize the less expensive surface capacitance touch screens or touchpads (hereinafter to be referred to as “surface cap panels”) to support multi-finger gestures or area gestures because there has not been a suitable method available for tracking more than one point of contact or for determining the outer boundaries of a large object as defined by area gesture method of Cirque Corporation® for multiple points of contact. In other words, it has not been possible to determine height and width of a large object.

Accordingly, it would be an advantage over the state of the art to be able to utilize area gestures defined by multiple points of contact with surface cap panels that are being used as touch screens and as touchpads. Such a system would enable new multi-touch technology to be used with simpler touch screen and touchpad technology.

The system and method below is initially directed to the use of measuring current in short and long aperture windows of time in order to determine the position of a finger or fingers on surface cap panels. However, the technique of using short and long aperture windows may be applied to more conventional touchpad technology that utilizes a single or multiple electrodes, and to a single layer of electrodes. Therefore, it is useful to describe mutual capacitance-sensing technology that can be modified to take advantage of the present invention.

The CIRQUE® Corporation touchpad is a mutual capacitance-sensing device and an example is illustrated as a block diagram in FIG. 3. In this touchpad 210, a grid of X (12) and Y (14) electrodes and a sense electrode 216 is used to define the touch-sensitive area 218 of the touchpad. Typically, the touchpad 210 is a rectangular grid of approximately 16 by 12 electrodes, or 8 by 6 electrodes when there are space constraints. Interlaced with these X (12) and Y (14) (or row and column) electrodes is a single sense electrode 216. All position measurements are made through the sense electrode 216.

The CIRQUE® Corporation touchpad 210 measures an imbalance in electrical charge on the sense line 216. When no pointing object is on or in proximity to the touchpad 210, the touchpad circuitry 220 is in a balanced state, and there is no charge imbalance on the sense line 216. When a pointing object creates imbalance because of capacitive coupling when the object approaches or touches a touch surface (the sensing area 216 of the touchpad 210), a change in capacitance occurs on the electrodes 212, 214. What is measured is the change in capacitance, but not the absolute capacitance value on the electrodes 212, 214. The touchpad 210 determines the change in capacitance by measuring the amount of charge that must be injected onto the sense line 216 to reestablish or regain balance of charge on the sense line.

The system above is utilized to determine the position of a finger on or in proximity to a touchpad 210 as follows. This example describes row electrodes 212, and is repeated in the same manner for the column electrodes 214. The values obtained from the row and column electrode measurements determine an intersection which is the centroid of the pointing object on or in proximity to the touchpad 210.

In the first step, a first set of row electrodes 212 are driven with a first signal from P, N generator 222, and a different but adjacent second set of row electrodes are driven with a second signal from the P, N generator. The touchpad circuitry 220 obtains a value from the sense line 216 using a mutual capacitance measuring device 226 that indicates which row electrode is closest to the pointing object. However, the touchpad circuitry 220 under the control of some microcontroller 228 cannot yet determine on which side of the row electrode the pointing object is located, nor can the touchpad circuitry 20 determine just how far the pointing object is located away from the electrode. Thus, the system shifts by one electrode the group of electrodes 212 to be driven. In other words, the electrode on one side of the group is added, while the electrode on the opposite side of the group is no longer driven. The new group is then driven by the P, N generator 222 and a second measurement of the sense line 216 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 212, 214 on the same rows and columns, and other factors that are not material to the present invention.

The process above is repeated for the Y or column electrodes 214 using a P, N generator 224

Although the CIRQUE® touchpad described above uses a grid of X and Y electrodes 212, 214 and a separate and single sense electrode 216, the sense electrode can actually be the X or Y electrodes 212, 214 by using multiplexing.

### BRIEF SUMMARY OF THE INVENTION

The present invention is a linear sensor (a single linear electrode) or a single layer sensor (a plurality of parallel and planar electrodes) that may be used in a single layer sensor, wherein a pinching gesture by two fingers can be detected on the linear or single layer sensors by measuring and then integrating current to determine if a finger is moving away from or towards an edge of the sensor, or it can be determined if the distance between the fingers is changing.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective view of an X and Y electrode grid touchpad as found in the prior art.

FIG. 2 is a perspective view of a surface cap panel as found in the prior art.

FIG. 3 is a block diagram of operation of an embodiment of a conventional touchpad having electrodes that is found in the prior art, and which is adaptable for use in the present invention.

FIG. 4 is a perspective view of a surface cap panel 10 that is made in accordance with the principles of the present invention.

FIG. 5 is a circuit diagram showing how a current measuring circuit comprised of a capacitor and a current measuring sensor is applied to the surface cap panel when a single object is present.

FIG. 6 is a top view of a surface cap panel in the first embodiment for use with the 8 Wire Method that can detect a plurality of objects.

FIG. 7 is a circuit diagram showing how a current measuring circuit comprised of two capacitors and two current measuring sensors are applied to the surface cap panel to detect a plurality of objects.

FIG. 8 is a graph showing the measurements made during different time apertures.

FIG. 9 is a top view of a surface cap panel that shows in which corners the electrodes of the current measuring circuit are placed for the 8 different measurements that must be made in order to detect a plurality of objects.

FIG. 10 is an alternative embodiment of a surface cap panel that can be used in the present invention.

FIG. 11 is a profile view of a single linear electrode in contact with two fingers.

FIG. 12 is a schematic diagram that represents an electrical circuit of FIG. 10.

FIG. 13 is a graph showing a curve that represents integrated current when a finger is relatively near to an edge of the linear electrode, and a curve that represents integrated current when a finger is relatively far from the edge.

FIG. 14 is a top view of a plurality of electrodes in a single layer.

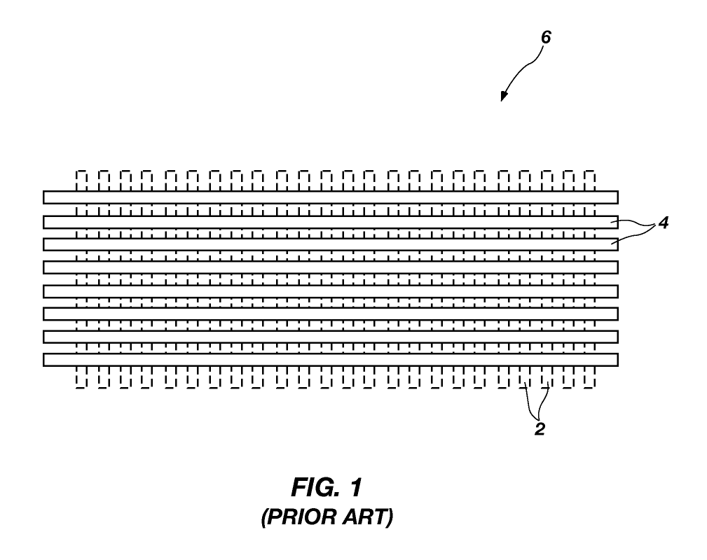

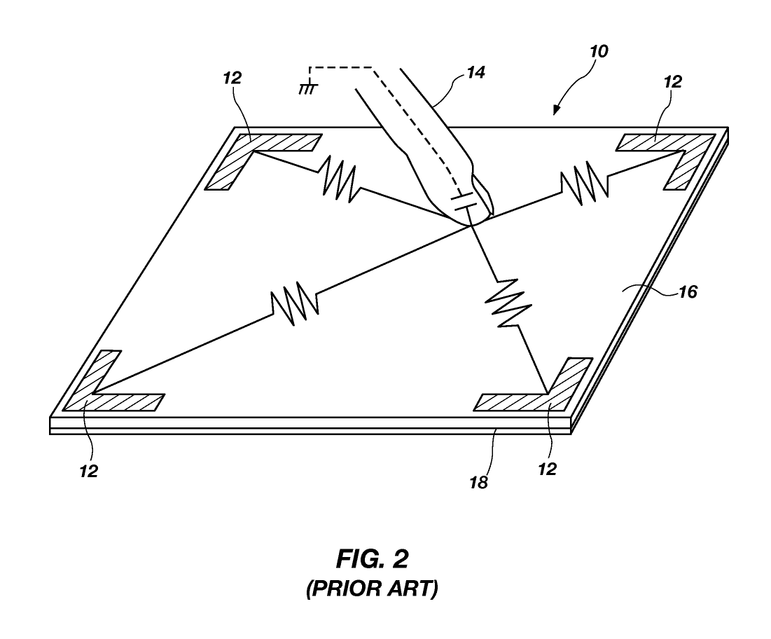

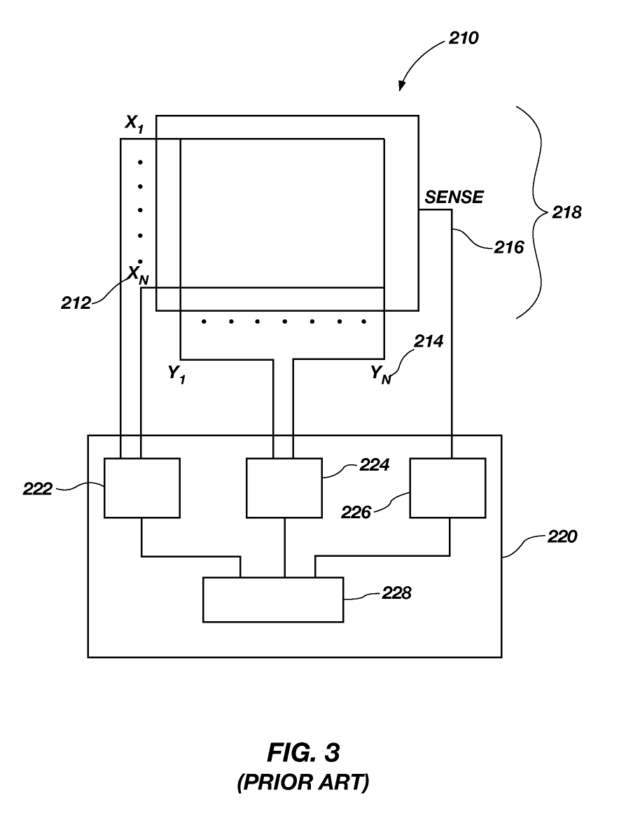

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

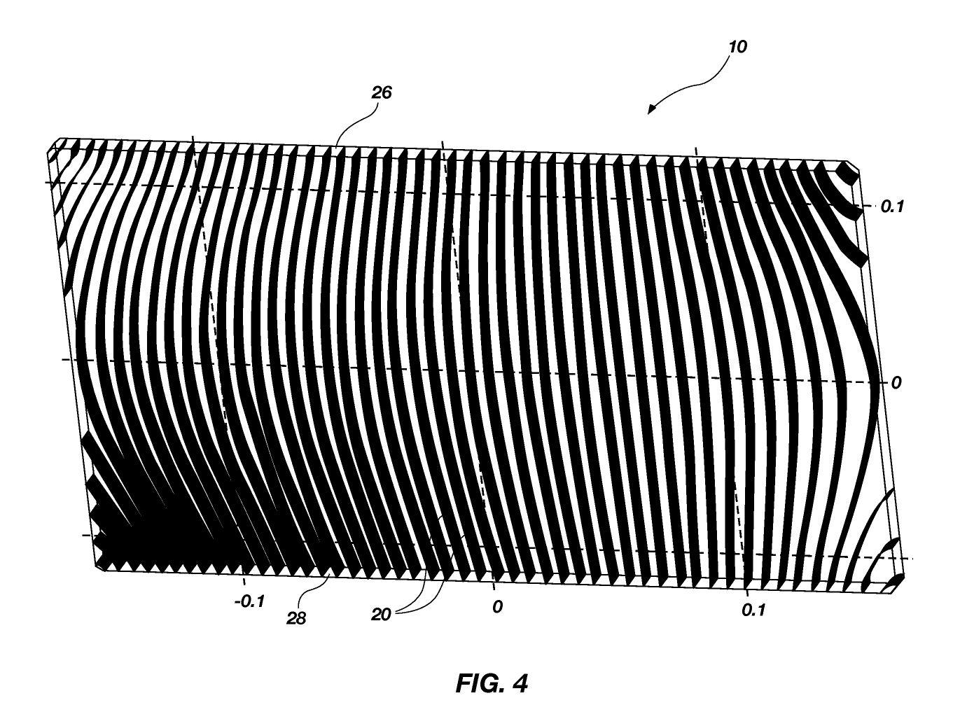

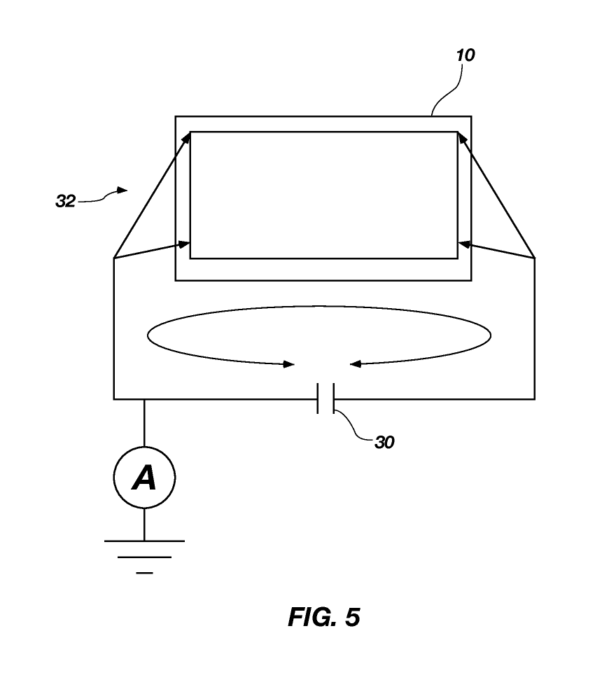

FIG. 4 is a perspective view of a surface cap panel 10 that is made in accordance with the principles of the present invention. As disclosed in the co-pending application, a new and novel approach to determining the position of an object on the touch panel is to charge a large capacitor and then apply this “flying capacitor” to two opposite ends of the touch panel 10. In the flying capacitor method of the present invention, this method measures the instantaneous and total current induced in a contact on a surface of the surface cap panel 20 when a constant voltage gradient is produced across the surface in a single axis. A sensitive current measuring circuit 32 as shown in FIG. 5 is applied to the surface cap panel 10 to make this current measurement. The flying capacitor 30 is used to charge the surface cap panel 10. Any charge that is removed from the surface cap panel 10 is measured with the current measuring circuit 32.

Linearity of a voltage gradient can improve accuracy of the surface cap panel 10 in FIG. 4. Therefore, in a first step, it is desirable but not essential that a lower resistance material be added around the edges of the touch panel 10 on the surface. The voltage gradient lines 20 become closer and more linear from a top edge 26 to a bottom edge 28.

In the co-pending application Ser. No. 12/592,283, it was explained that four measurements were needed in order to determine the location of a single object on the surface cap panel 10. The present invention extends the capability of the “flying cap” method of position determination by using what is referred to as the “8 Wire Method”.

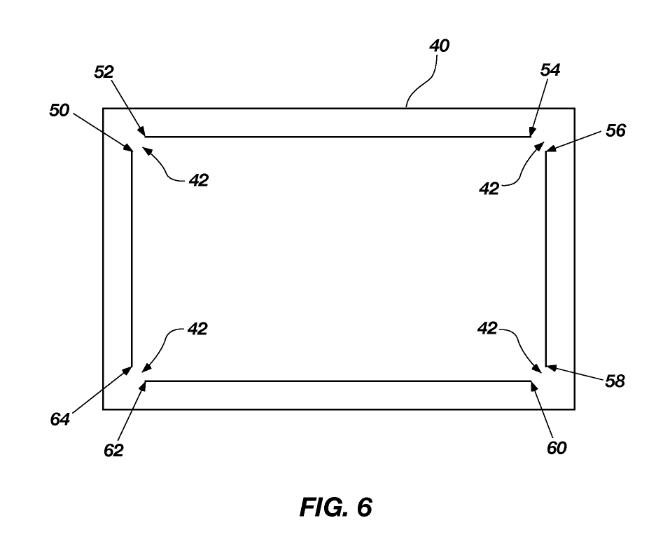

The surface cap panel 40 used for the 8 Wire Method is shown in FIG. 6. In this surface cap panel 40, a gap 42 is created in each corner so that individual electrodes can be connected to the low resistance material at each end of the low resistance path. Thus, electrodes are coupled at 50, 52, 54, 56, 58, 60, 62 and 64, which are the 8 wires of the 8 Wire Method. The low resistance paths are separated but are sufficiently close to each other so as to form the constant voltage gradient as in the 4 Wire Method of the co-pending application.

The 8 Wire Method is performed by measuring the charge transfer rate in addition to the total charge transfer for each event. An event is defined as when a measurement is taken. The charge transfer rate is used to determine the distance between two points of contact on the surface cap panel 40. Height and width information related to the distance between the two points of contact is thus determined by doubling the number of electrodes at the corners of the surface cap panel 40.

Figure/shows a modified current measurement circuit 70 that is used in the 8 Wire Method in FIG. 7, two flying capacitors 72 and 74 are applied simultaneously to the surface cap panel 40. Simultaneous application of the flying capacitors 72 and 74 enables relative measurement of the aggregate resistance between contacts and horizontal and vertical low resistance paths on the surface cap panel 40.

Specifically, the position of the contacts on the surface cap panel 40 is determined by measuring the current through the multiple fingers and determining the effective Norton resistances for each parallel axis to the contacts.

The Norton resistance is derived by two (2) successive integrations of the current in each axis. The two (2) measurements integrated over a long and short aperture of time allow for the RC time constant to be determined. The position or proximity of a contact to an edge is then derived from the computed resistance between the contact and the edge. The total integrated current (area under the curve below) is proportional to the finger capacitance.

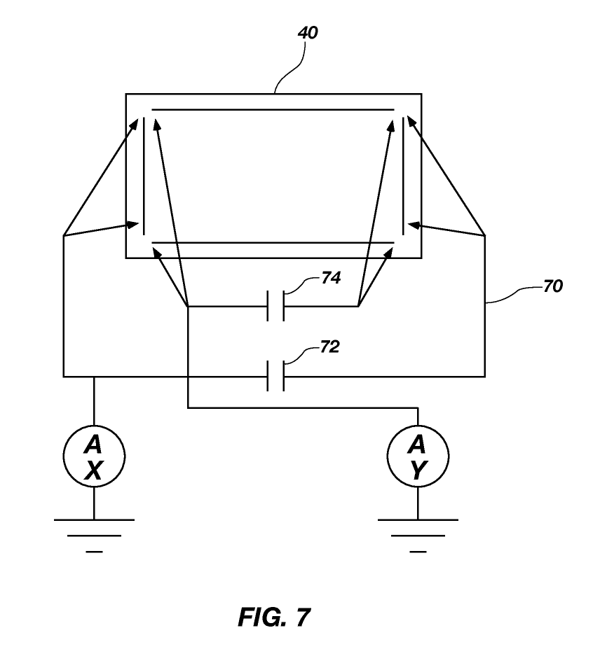

The pinch gesture in one axis shown in FIG. 8 illustrates the changes in the time constant of the current as contacts are moved apart. 2/1 are before and after measurements as the fingers are first close together (2 and 4) and then farther apart (1 and 3). A larger “short measurement” of 1 versus 2 indicates a larger pinch in that axis.

The present invention also extends the capability of the previous 4 Wire “flying cap” method by measuring rapid changes in capacitance to detect a second point of contact. Holding the first point of contact position fixed and moving the second point of contact provides midpoint location information that can now be used, for example, to provide information for a “rotate” gesture.

The 8 Wire Method operates on the same principle as the 4 Wire Method of the co-pending application because individual electrodes are connected to the low resistance material at each end of the electrodes. The current induced in the low resistance material is many times larger than the current induced in a finger or other point of contact on the surface cap panel.

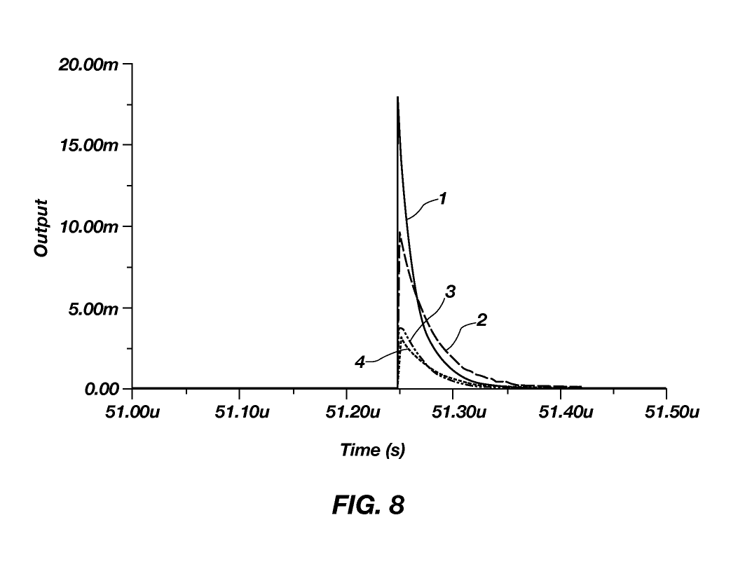

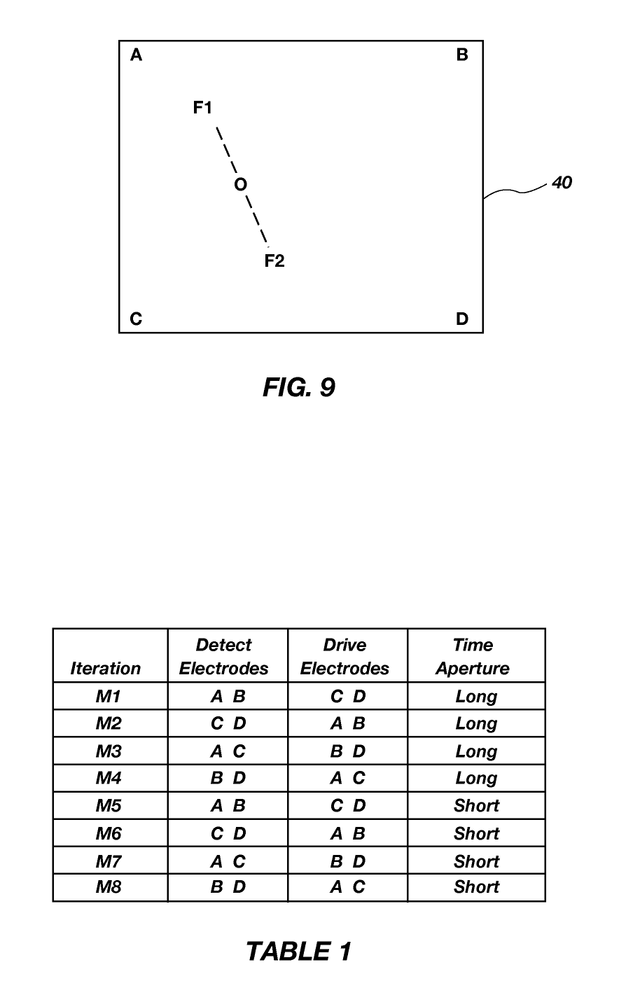

FIG. 9 is a block diagram of a surface cap panel 40 of the present invention. The corners of the surface cap panel are labeled A, B, C and D. F1 is an arbitrarily selected point of contact for a first pointing object. F2 is an arbitrarily selected point of contact for a second pointing object. O is labeled as the midpoint between points of contact F1 and F2.

Oppositely charged capacitors are applied successively between Detect Electrodes and Drive Electrodes. Charge that is leaving the surface cap panel in a specific aperture of time is accumulated in a specific aperture of time. There are 8 different combinations of electrode patterns and accumulation time apertures. There are a total of 8 different measurements that must be taken. The 8 measurements or combinations of electrodes and time apertures are listed as Iterations in TABLE 1.

The calculations that must be performed are as follows: Z1−M1+M2, Z2=M3+M4, X=M3/Z2, Y=M1/Z1, Z=Z1+Z2. A calculation to analyze a pinching movement is thus defined as Pinch=M1/M5+M2/M6+M3/M7+M4/M8.

The aspect ratio related to the vertical and horizon al spacing of contacts is determined by the average of the ratio of Ax and Ay for each measurement (M1 through M8). Thus MRn=(Axn−Ayn)/(Axn+Ayn). And the Aspect Ratio=(MR1/MR5+MR2/MR6+MR3/MR7+MR4/MR8)/4

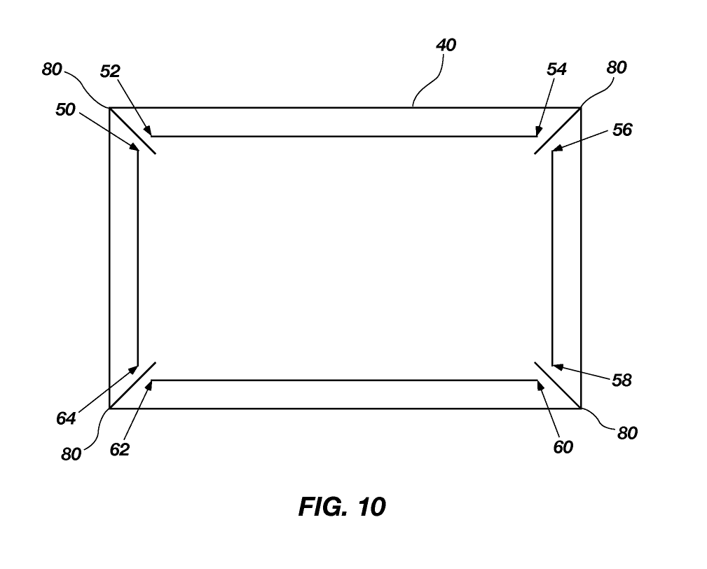

FIG. 10 is provided as an alternative embodiment of the surface cap panel 40. In this figure a small slot 80 is created in the surface resistive material at each corner to further separate the electrodes 50, 52, 54, 56, 58, 60, 62 and 64. The slot 80 extends from the outside corner protruding up to the active area of the surface cap panel 40 where contacts are made.

The principles of the present invention may now be applied to a linear sensor comprised of a single electrode, and to a single layer sensor comprised of a plurality of parallel electrodes in a plane. More specifically, the principles of the present invention may be directed to a gesture commonly known as a pinch gesture. In a pinch gesture, two fingers or a finger and thumb (hereinafter referred to as fingers) are brought together or moved apart. A typical application for a pinch gesture is to perform a “zoom in” function when the two fingers are brought together, and to perform a “zoom out” function when the two fingers are moved apart. However, any function may be applied to the moving together and moving apart motions of the two fingers. What is important is that the two finger gesture be recognized, and that the motion of the fingers is tracked to thereby determine if the fingers are moving together or apart so the appropriate function can be performed.

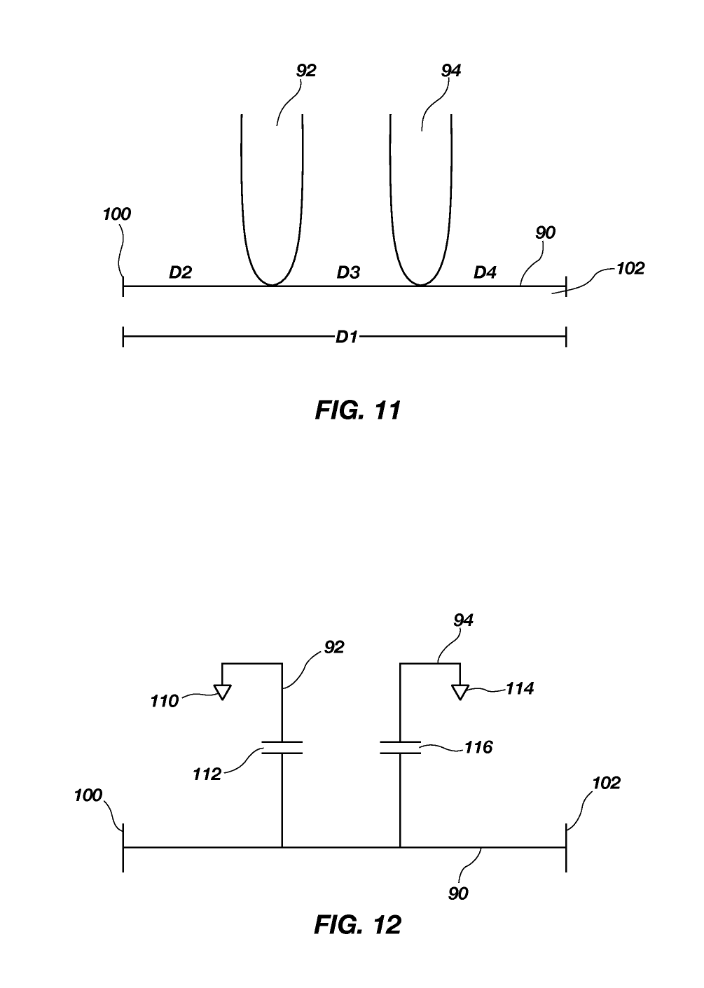

FIG. 11 is a profile view of a single or linear electrode 90. Two fingers 92 and 94 appear to be touching the single electrode 90. It is assumed that a layer of a non-conductive or dielectric material such as glass separates the fingers 92, 94 from physical contact with the single electrode 90.

It will be assumed that the motion being performed by the finger 92 is always the same motion as the finger 94. In other words, the fingers 92, 94 are performing a pinch gesture, wherein the fingers 92 and 94 are either moving towards each other or are moving part from each other. Therefore, in a simplest case, it is only necessary to know if one of the fingers is moving away from or towards an edge of the single electrode 90, in order to know if the fingers 92, 94 are moving towards each other or apart from each other. If finger 92 is moving away from edge 100, then fingers 92, 94 are moving towards each other, and if finger 92 is moving towards edge 100, then fingers 92, 94 are moving apart from each other.

In this embodiment, the present invention uses the technique of taking short aperture measurements and long aperture measurements described above for the surface cap concept. Thus, while the present invention can be used to determine the distance of each finger from an outer edge of the single electrode 90, and from those measurements determine the distance between the fingers, such information may or may not be needed in order to just perform the pinch gesture.

Specifically, the distance between the fingers 92, 94 along the single electrode 90 can be determined by measuring the electrode resistance from the edge 100 to the finger 92, and from an edge 102 to the finger 94. However, it is not necessary to know the spacing between the fingers 92, 94 if it is only necessary to know if the pinch gesture is being performed. Nevertheless, if the length D1 of the single electrode 90 is known, and it is possible to determine the distance D2 between the edge 100 and the finger 92, and the distance D4 between the edge 102 and finger 94, then the distance D3 between the fingers 92, 94 can be precisely determined.

FIG. 12 shows a schematic diagram of FIG. 11. The first finger 92 is shown with a grounded end 110, and a capacitance 112 such as the capacitance through a glass layer on the single electrode 90. Similarly, the second finger 94 is shown with a grounded end 114 and a capacitance 116 which is the capacitance through the glass layer on the electrode 90.

An AC signal is applied to the electrode 90 in order for the signal to get across the capacitances 112 and 116. Measurement circuitry is used to measure the current passing through the fingers 92, 94. The signal must be applied from each edge of the single electrode 90 in order to determine the distance of each finger from each edge.

The RC time constant, group delay or phase shift is proportional to the resistance of the single electrode 90 and can be found by two successive measurements of current using a short and long aperture measurement.

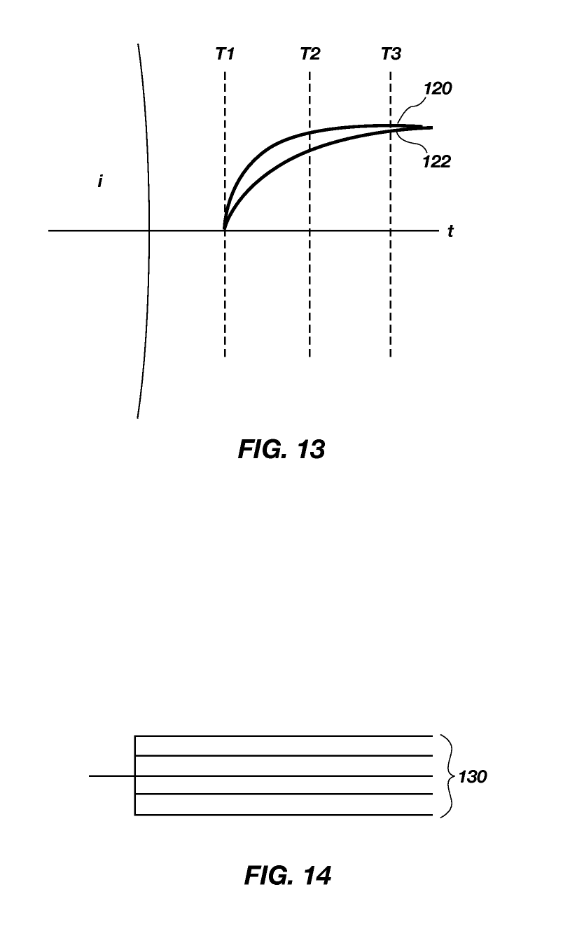

For example, consider FIG. 13 which shows a graph of current integrated as a function of time signal is applied at time T1 and the integrated current is measured at time T2 and at time T3. Time T2 is the short aperture measurement, and time T3 represents the long aperture measurement. When the signal is first applied to the electrode 90, the current initially rises rapidly and then levels off as the functional equivalent of a capacitor is charged. However, the rate at which the capacitor is charged is a function of the distance of a finger from the edge of the electrode 90.

Consider the finger 92 and a signal, such as a square wave, being applied from the edge 100. If the distance D2 between the finger 92 and the edge 100 is relatively small, then the capacitor 112 will charge rapidly because the resistance of the single electrode 90 is small. The curve 120 represents the integrated current. Notice that the integrated current, is almost the same at time T2 and time T3. This is representative of the distance D2 being relatively short.

Next, consider curve 122. Curve 122 is the resulting integrated current curve when the distance D2 is larger and the resistance of the single electrode 92 is thus greater. Thus it is now seen how a comparison or a ratio of two successive calculations of integrated current can reveal whether or not the distance D2 is growing smaller or larger.

If a precise location of the finger 92 is not needed but only a determination if the finger is moving, then the curves 120, 122 only need to be compared to each other. If the curves are substantially identical, then the finger 92 is no moving. If the second curve is flatter than the first curve, then the finger 92 is moving away from the edge 100, and if the first curve is flatter than the second curve, then the finger 92 is moving towards the edge of the linear electrode 90.

Another way to characterize the data is that a relative position for the fingers is being given. This is useful when it is only necessary to know if a finger is moving, and in which direction. The first curve can thus be considered to be a first position, and the second curve can be considered to be a second position relative to the first.

If the precise location of the finger 92 on the linear electrode 92 is needed, the distance D2 is first determined by measuring current to the finger 92 and integrating the current over time, the first measurement or short aperture measurement taken at time T2 and the second or long aperture measurement taken at time T3. This information can be used to determine a precise location. Then, to determine if the distance D2 is growing larger or smaller, a subsequent set of two measurements and integration of current are taken at times T2 and T3.

Therefore, if curve 120 represents the first set of calculations and curve 122 represents the second set of calculations, then it is known that finger 92 is moving away from the edge 100 and towards the finger 94. Similarly, if curve 122 represents the first set of calculations and curve 120 represents the second set of calculations, then it is known that finger 92 is moving towards edge 100 and therefore away from finger 94.

It is an aspect of the invention that a precise distance D2 may be determined if a precise location of the finger 92 along the length of the single electrode 90 is needed.

Another way to analyze the results of integrated current represented by the curves 120 and 122 is to state that the ratio of integrated current of curve 120 when the integrated current at time T3 is only slightly larger than the amount of integrated current at time T2. The ratio of integrated currents may thus be characterized as approaching 1:1 as the distance D2 becomes small, or the finger 92 moves closer to the edge 100. Likewise, it is possible to characterize the curve 122 as stating that the ratio of integrated current at time T3 is larger when compared to the integrated current at time T2 as the finger 92 moves away from the edge 100, or simply greater than 1:1. We may therefore state that curve 120 represents a smaller ratio of integrated current than the curve 122.

Subsequent measurements and integrations of current are taken to track the movement of finger 92, finger 94 or both fingers 92 and 94. Movement of fingers 92 and 94 towards each other or apart from each other may be considered to correspond to the pinch gesture. The gesture may be terminated when movement of one or both of the fingers 92, 94 ceases, and may be resumed when movement of one or both of the fingers begins again. Therefore, it may be necessary to track the movement of the fingers 92, 94 from the edges 100, 102 of the single electrode if it is necessary to know if movement is occurring in either of them.

It should be understood that various calculations may be performed from the measurements of current that are being taken. Integrated current, resistance, voltage or any measurable or calculable quantity can be used from the information gathered from the measurement circuits that can be placed on the single electrode 90. The measured or calculated values may then be compared to each other in order to determine the relative position and the direction of movement of a finger or fingers.

While the embodiment above was directed to a single electrode 90, the principles are also equally applicable to a single layer of a plurality of parallel electrodes 130 as shown in FIG. 14. The principles of the present invention may also be applied to a multi-layer touchpad.

The measuring circuitry that is used by the present invention is capable of accurately measuring current flow through at least one electrode, the current flow caused by a signal generator applying a signal to the at least one electrode and at least one finger making contact with a dielectric material disposed over at least one electrode. The measuring circuitry includes a processor for recording measurements and for integrating current flow through the at least one electrode.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for determining if a multi-object pinch gesture is being performed, said method comprising:
1) providing a linear electrode comprised of an insulating substrate, the linear electrode disposed on the substrate, and a dielectric disposed on the linear electrode, and a means for measuring current flow at either end of the linear electrode;
2) applying a signal to a first edge of the linear electrode;
3) measuring a first current through a first finger nearest to the first edge of the linear electrode using a first short aperture measurement and a first long aperture measurement;
4) measuring a second current through the first finger nearest to the first edge of the linear electrode using a second short aperture measurement and a second long aperture measurement; and
5) determining if a pinch gesture is being performed by the first finger.

2. The method as defined in claim 1 wherein the method further comprises integrating the measured first current, integrating the measured second current, and comparing the integrated first and second currents to determine if the first finger is moving.

3. The method as defined in claim 2 wherein the method further comprises:
1) integrating the first current using the first short aperture measurement and integrating the first current using the first long aperture measurement to determine a first position of the first finger;
2) integrating the second current using the second short aperture measurement and integrating the second current using the second long aperture measurement to determine a second position of the first finger; and
3) comparing the first position of the first finger relative to the second position to thereby determine if the first finger is moving.

4. The method as defined in claim 1 wherein the method further comprises:
1) applying a signal to a second edge of the linear electrode;
2) measuring a first current through a second finger nearest to the second edge of the linear electrode using a first short aperture measurement and a first long aperture measurement;
3) measuring a second current through the second finger nearest to the second cane of the linear electrode using a second short aperture measurement and a second long aperture measurement; and
4) determining if a pinch gesture is being performed by the second finger.

5. The method as defined in claim 4 wherein the method further comprises integrating the measured first current, integrating the measured second current, and comparing the integrated first and second currents to determine if the second finger is moving.

6. The method as defined in claim 5 wherein the method further comprises:
1) integrating the first current using the first short aperture measurement and integrating the first current using the first long aperture measurement to determine a first position of the second finger;
2) integrating the second current using the second short aperture measurement and integrating the second current using the second long aperture measurement to determine a second position of the second finger; and
3) comparing the first position of the second finger relative to the second position to thereby determine if the second finger is moving.

7. The method as defined in claim 3 wherein the method further comprises determining that a pinch gesture is being performed when the first position of the first finger is different than the second position of the first finger.

8. The method as defined in claim 6 wherein the method further comprises determining that a pinch gesture is being performed when the first position of the second finger is different than the second position of the second finger.

9. A system for determining if a multi-object pinch gesture is being performed on a linear sensor, said system comprised of:
an insulating substrate;
a single linear electrode disposed on the insulating substrate;
a dielectric disposed on top of the linear electrode;
a measuring circuit that can be coupled to a first end or a second end of the linear electrode;
a signal generator for applying a signal to the first end or the second end of the linear electrode; and
a processor for integrating a current measured at the first end or the second end of the linear electrode.

10. A system for determining if a multi-object pinch gesture is being performed on a multi-touch sensor, said system comprised of:
an insulating substrate;
a plurality of parallel electrodes disposed on the insulating substrate;
a dielectric disposed on top of the plurality of parallel electrodes;
a measuring circuit that can be coupled to a first end or a second end of the plurality of parallel electrodes;
a signal generator for applying a signal to the first end or the second end of the plurality of parallel electrodes; and
a processor for integrating a current measured at the first end or the second end of the plurality of parallel electrodes.

11. A method for determining if a multi-object pinch gesture is being performed, said method comprising:
providing a linear electrode comprised of an insulating substrate, the linear electrode disposed on the substrate, and a dielectric disposed on the linear electrode, and a means for measuring current flow at either end of the linear electrode;
2) applying a signal to a first edge of the linear electrode;
3) measuring a first current at a first edge of the linear electrode using a first short aperture measurement and a first long aperture measurement;
4) measuring a second current at a first edge of the linear electrode using a second short aperture measurement and a second long aperture measurement; and
5) determining if a pinch gesture is being performed by the first finger.
